(19) United States
(12) Patent Application Publication
(10) Pub. No.: US 2016/0208740 A1
(43) Pub. Date: Jul. 21, 2016

(54) ACTIVE LOCK WITH MOBILIZATION ASSISTANCE AND THRUST REVERSER INCORPORATING SUCH A LOCK

(71) Applicant: AIRCELLE, Gonfreville L'Orcher (FR)

(72) Inventor: Corentin HUE, Le Havre (FR)

(21) Appl. No.: 14/704,267

(22) Filed: May 5, 2015

Related U.S. Application Data
(63) Continuation of application No. PCT/FR2013/052871, filed on Nov. 27, 2013.

(30) Foreign Application Priority Data
Nov. 28, 2012 (FR) 12/61332

(51) Int. Cl. F02K 1/76; B64D 33/04

(52) U.S. Cl. CPC F02K 1/766; B64D 33/04; F05D 2260/30

(57) ABSTRACT

The present disclosure concerns thrust reversers for a nacelle of a turbojet engine having a sliding cover. The active lock is rigidly connected to a fixed structure and engages with a locking interface of a mobile structure by a tilting bolt driven by a controlled electric motor. The tilting bolt is tiltably mounted with a pusher to push the mobile structure away from the fixed structure during the deployment of the mobile structure relative to the fixed structure driven by the controlled electric motor via mobilizing the active lock according to a predefined sequence of movements of the tilting bolt or the pusher.

### CROSS-REFERENCE TO RELATED APPLICATIONS

This application is a continuation of International Application No. PCT/FR2013/052871, filed on Nov. 27, 2013, which claims the benefit of FR 12/61332, filed on Nov. 28, 2012. The disclosures of the above applications are incorporated herein by reference.

### FIELD

The present disclosure relates to an active lock with mobilization assistance and a thrust reverser for nacelle of turbojet engine incorporating such a lock.

### BACKGROUND

The statements in this section merely provide background information related to the present disclosure and may not constitute prior art.

In the state of the art, it is known to have a lock in order that the moveable structure of a thrust reverser will not start the deployment thereof without a specific control of its actuators. Such an accidental deployment, under the action of tremors, for example during operation in flight or on take-off, would make the apparatus equipped with such a thrust reverser run a serious risk.

The lock allows fastening an interface of the moveable structure of the thrust reverser to a point of the associated stationary structure, such as the nacelle of the turbojet engine which the thrust reverse equips. When the control for deploying the thrust reverser is transmitted, a first order for freeing the associated lock is received and activates the electric motor or actuator which mobilizes a moveable bolt of the lock which hence frees the locking interface of the moveable structure of the thrust reverser. A specific actuator for deploying the thrust reverser is then activated.

On the contrary, upon the folding of the thrust reverser, the bolt of the lock meshes with the locking interface of the moveable structure as a result of the electric motor or actuator of the lock. The thrust reverser is then correctly neutralized and the risk of accidental deployment is reduced.

In document FR 2 761 534, it is described a closing and locking device suitable for a thrust reverser. The device is adapted with a bolt liable to push the locking interface towards the closing position of the moveable structure which is secured to it thanks to an additional movement caused by the motor which drives the bolt.

In the state of the art, an issue has become apparent in that during the deployment of the moveable structure of the thrust reverser, there exists an additional resistance to the inertia of only the moveable structure and which should be overcome at the start of the deployment of the thrust reverser.

It is known to design a thrust reverser with an oversizing of its deployment actuator which allows helping the opening of the moveable structure despite the existence of this additional resistance.

However, such an oversizing is detrimental especially when it leads to using an over-retractability of the moveable structure of the thrust reverser.

### SUMMARY

The present disclosure provides an active lock secured to a stationary structure and which cooperates with an interface for locking a moveable structure by means of a bolt driven by a controlled electric motor. According to the present disclosure, the bolt is mounted tilted with a pusher intended to push back the movable structure from the stationary structure during the deployment of the moveable structure relatively to the stationary structure driven by the electric motor controlled by a means for mobilizing the lock according to a determined sequence of movements of the tilting bolt and/or the pusher.

According to other features:

the tilting bolt and the pusher are mounted on shafts driven by the means for mobilizing the lock and having a common axis, the bolt assumes a hook shape, and the pusher includes an articulated latch on a lever for applying a thrust force during the start of the deployment of the moveable structure relatively to the stationary structure;

the tilting bolt and the pusher are mounted on shafts driven by the means for mobilizing the lock having a common axis, the bolt assumes a hook shape, and the pusher includes an end in contact with the moveable structure in its closing state having a cam profile for applying a thrust force during the start of the deployment of the moveable structure relatively to the stationary structure;

the means for mobilizing the lock includes declutchable connection means between the electric motor of the lock and the tilting bolt and/or between the electric motor of the lock and the pusher, in such a manner that a determined sequence of movements of the tilting bolt and pusher be applied during the deployment of the moveable structure;

the declutchable connection means include claws respectively associated to the tilting bolt and pusher, cooperating with elastic means which repel them from each other when the electric motor connected to any of the claws ceases to be active, in that any of the claw disks is driven on the shaft of the electric motor, the connection between the shaft and any of the disks, the claws and the control of the electric motor arranged for determining said sequence of movements;

the declutchable connection means include a first disk having a groove formed and associated to the tilting bolt, the groove cooperating with at least one cam mounted on a second disk associated with the pusher and at least one spur on a stationary disk of which the relative positions, the activation of the electric motor coupled to the at least any of the disks of the declutchable connection means, determine said sequence of movements;

The declutchable connection means include a plurality of toothed wheels, meshed by one of them to a wheel driving the electric motor, a toothed wheel of said plurality carrying a shaft associated with the tilting bolt and another toothed wheel of said plurality carrying a shaft associated with the pusher, any of the wheels associated with the pusher or the bolt including a simple toothed sector and being returned by elastic means in a rest position when the electric motor is not actuated, the wheels and the toothed sector being arranged for determining said sequence of movements;

The present disclosure also relates to a thrust reverser for turbojet engine nacelle, incorporating at least one active lock discussed above. According to the present disclosure, the stationary structure is associated with the turbojet engine nacelle and the moveable structure is associated with at least one sliding cowl of the thrust reverser.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIGS. 1a to 1c represent three successive states of one form of the active lock of the present disclosure;

FIGS. 2a and 2b represent the disposition of the active lock of the form of FIGS. 1a to 1c set up in a stationary structure relatively to a moveable structure, nominally within the framework of a thrust reverser for a turbojet engine nacelle;

FIGS. 3a to 3d represent four successive states of another form of the active lock of the present disclosure;

FIGS. 4a and 4b represent the disposition of the active lock of the form of FIGS. 1a to 1c set up in a stationary structure relatively to a moveable structure, nominally within the framework of a thrust reverser for turbojet engine nacelle;

FIGS. 5a to 5d represent the successive states of one form of a part of an active lock according to the first or the second form;

FIGS. 6a and 6b represent two views of a second form of a part of an active lock according to the first or second form;

FIG. 7 represents four successive states (a) to (d) of the part of the second form of FIGS. 6a and 6b;

FIGS. 8a to 8c represent the successive states of a third form of a part of an active lock according to the first or second form; and

FIG. 9 represents the third form of a part of an active lock according to the first or second form.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

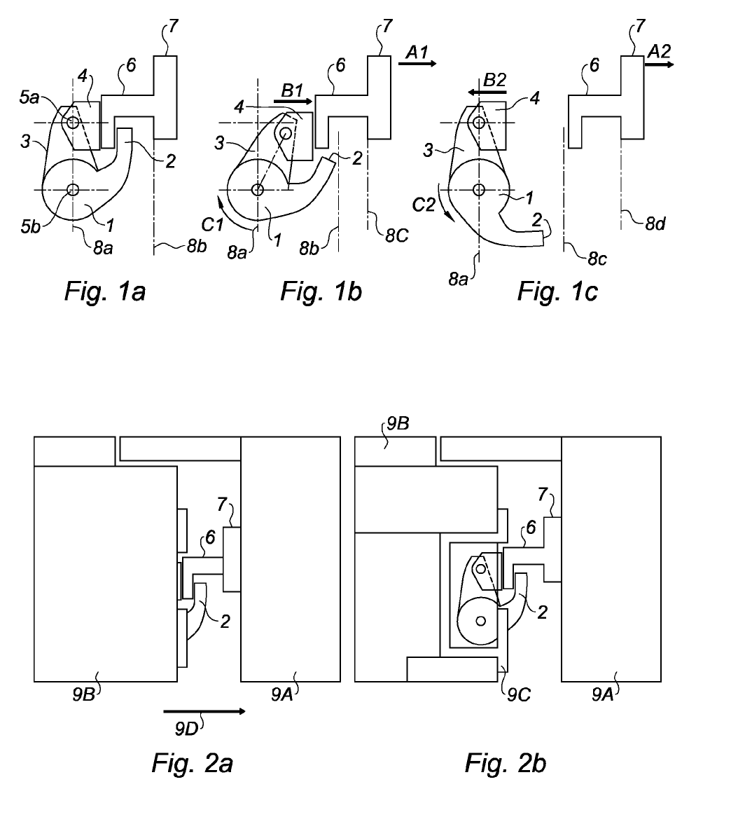

In FIGS. 1a to 1d, it has been represented the successive states of an active lock according to a first form of the present disclosure. On an axis 5b are mounted a tilting bolt 2 and a pusher 3, 4. The tilting bolt meshes in closing position of the moveable structure 6, 7 inside a locking interface 6, in the shape of a hook, secured to the moveable structure 7. The latter is immobilized in the state represented on FIG. 1a.

The pusher is composed in the form of two pieces including a lever 3 turning on the aforementioned axis 5b and a latch 4, articulated on an axis 5a mounted on the end of the lever 3 opposite to the one secured to the axis 5b. The movement of the two main pieces of the active lock of the present disclosure, namely the tilting bolt and the pusher, is determined by a means 1 for mobilizing the active lock which cooperates with an electric motor. Their movement, joint or separate, is then distributed according to predetermined sequences between the tilting bolt 2 and the pusher 3, 4 during the deployment of the moveable structure 6, 7 (FIGS. 2a, 2b).

On FIG. 1a, it has been represented the closing state of the active lock 1-4, the moveable structure was in closing position on the position 8b marked on the right of the axis 8a connecting the axes 5b and 5a, the pusher 3, 4 being lifted and the tilting bolt 2, meshed in the locking interface 6 secured to the moveable structure 7.

On FIG. 1b, the active lock has started the opening sequence which allows freeing the locking interface 6 by making the tilting bolt 2 descend thanks to a rotation C1 applied by the electric motor (non represented) coupled to the means 1 for mobilizing the active lock. In the same period, or during a second period according to the configuration of the means 1 for mobilizing the active lock, the pusher 4 follows a movement B1 which repels the moveable structure 7 in a response movement A1, as the lever 3 has turned by a given angle whereas the face of the latch 4 remains in contact with a corresponding face of the locking interface 6. The moveable structure 7 then achieves a position more on the right 8c in comparison with the closing position 8b.

It may be noted that the movement A1 may be applied without the actuators (not represented) of the moveable structure 7 be actuated only by the action of the active lock of the present disclosure. Thus, it is possible to overcome the opening resistance of the moveable structure, and in particular, the deployment of the sliding cowl of a thrust reverser secured to this moveable structure.

On FIG. 1c, it has been represented the rest of the sequence applied by the means 1 for mobilizing the active lock. The movement A2 of the moveable structure 6, 7 is now pursued as a result of its own actuators (not represented) its instantaneous position 8d moving away from the point reached 8c at the state of FIG. 1b. In the same period, the rotation C2 applied by the means 1 for mobilizing the active lock allows on the one hand to place the tilting bolt 2 in a waiting to close position, and on the other hand to return the pusher 3, 4 in closing position according to the movement B2.

When the moveable structure 7 resumes the closing position (FIG. 1a) the means 1 for mobilizing the active lock will apply a rotation on the tilting bolt 2 only to make it ascend from the waiting position of FIG. 1c to the meshing position of FIG. 1a with the locking interface 6 of the moveable structure 6 which will have resumed its closing position 8b as a result of its own actuators.

On FIGS. 2a and 2b, it has been represented an application of the active lock of the form of FIGS. 1a to 1c to a thrust reverser for turbojet engine nacelle. On FIG. 2a, the active lock 2 is masked by a cowl of a stationary structure 9A such as the body of the turbojet engine nacelle.

The separation between the stationary structure 9A and the moveable structure 9B which includes the cowl or stopper of the thrust reverser, lets the locking interface 6 and the fixing thereof 7 to the moveable structure appear such that during the deployment of the thrust reverser the sliding cowl of the thrust reverser follows the translation movement 9D.

On FIG. 2b, which represents like FIG. 2a the closing state of the thrust reverser, the active lock of the form of figures la and 1 c is represented mounted in a casing 9C with the tilting bolt 2 meshed in the locking interface 6 of the moveable structure 7; 9A.

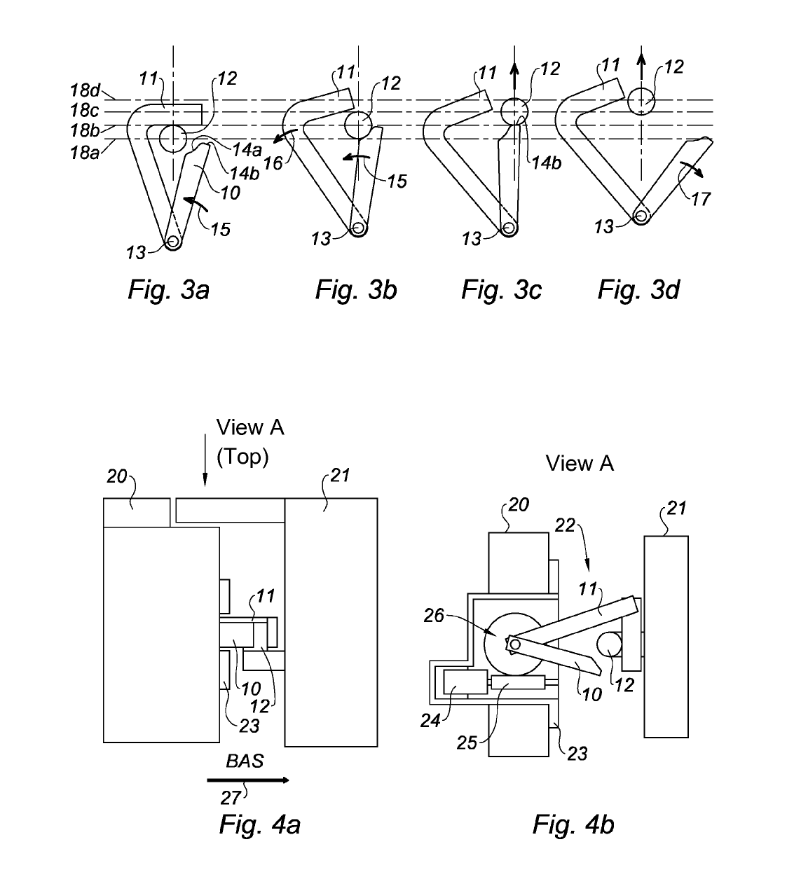

In FIGS. 3a to 3c, it has been represented the operating states of an active lock in a second form of the present disclosure. The active lock of this form includes a tilting bolt 11 articulated on a motor axis 13 and which assumes a bent shape in such a manner that the tilting bolt 11 retains in closing position a part 12 connected to the moveable structure. The motor axis 13 is secured to a stationary structure which is non-represented. The stationary and moveable structures are identical to the structures 9B and 9A of the form of FIGS. 2a and 2b.

A pusher 10 is constituted of a lever articulated on the motor axis 13 already associated with the tilting bolt 11 and the two moveable members 10 and 11 of the active lock of this second form are both mobilized by an electric motor associated with a means for mobilizing the active lock, here not represented but similar to the means 1 for mobilizing the active lock of the first form represented on FIGS. 1a to 1c.

The free end of the pusher 10 assumes a cam shape facing the part 12 connected to the moveable structure. The cam shape includes a first part 14a to be suited to the shape facing the part 12 connected to the moveable structure when it is in closing state such as on FIG. 3a. In this closing state, the part 12 is at the level marked by the mixed line 18a characteristic of the closing state of the moveable structure and the active lock. The cam shape of the pusher 10 includes a second part 14b which promotes the thrust of the pusher 10 on the part 12 connected to the moveable structure.

To this end, the motor associated with the means for mobilizing the active lock (not represented) begins a movement of tilting 16 the tilting bolt 11, FIG. 2b in such a manner that the part 12 connected to the moveable structure is cleared from the active lock. Then, the motor and the means for mobilizing the active lock applies a rotation 15 to the pusher 10 in such a manner that the second part 14b starts to repel the part 12 connected to the moveable structure in position 18b.

On FIG. 2c, the pusher 10 has pursued its travel in such a manner that it has repelled the part 12 connected to the moveable structure in its extreme position 18c. The natural actuators of the moveable structure, that is to say, in an exemplary application of the present disclosure to a thrust reverser, to a sliding cowl of thrust reverser, thus enter into action and the part 12 connected to the moveable structure thus pursues in instantaneous position 18d its deployment travel of the thrust reverser autonomously from the active lock. During this period the motor of the means for mobilizing the active lock of the second form of the present disclosure brings the pusher 10 back to a waiting position according to the rotation 17.

The closing sequence is triggered by a specific control in such manner that the pusher 10 takes up again its position of FIG. 3a in order to receive the part 12 connected to the moveable structure in closing state, then the tilting bolt 11 folds over on the other hand behind the part 12 connected to the moveable structure. One will have returned to the state of FIG. 3a.

In FIGS. 4a and 4b, it has been represented another exemplary application of the present disclosure to a sliding cowl of thrust reverser similar to that of FIGS. 2a and 2b. The stationary structure 20 carries the active lock by means of a casing 23 inside which are mounted an electric motor 24 coupled to a reducer itself mechanically coupled to a means 26 for mobilizing the active lock, the part 12 connected to the moveable structure 21 assumes a hook shape. It is to be noted that the FIG. 4b is a schematic top view of FIG. 4a.

It will now be described three forms of the means 1 or 26 for mobilizing the active lock described for either one of the forms of the active lock. The mobilization means includes in the present disclosure an electric motor and declutchable connection means between the electric motor of the lock and the tilting bolt and/or between the electric motor of the lock and the pusher. The effect of the declutchable connection means of the present disclosure is that it be applied a determined sequence of movements of the tilting bolt and the pusher during the deployment of the moveable structure.

Thus, it is possible to guarantee sequences of joint or separate movements of the tilting bolt and pusher synchronized with the deployment and folding of the moveable structure when the latter is associated with the sliding cowl of a thrust reverser for turbojet engine nacelle. Preferably, the tilting bolt and pusher are articulated on an axis which is common to two separate shafts of the declutchable connection means which then couple in a determined manner any one of or the two separate shafts with the action of the electric motor associated with the means for mobilizing the active lock of the present disclosure. According to the cases, as it will be explained, elastic return means exert part of the motor force in the absence of action of the electric motor.

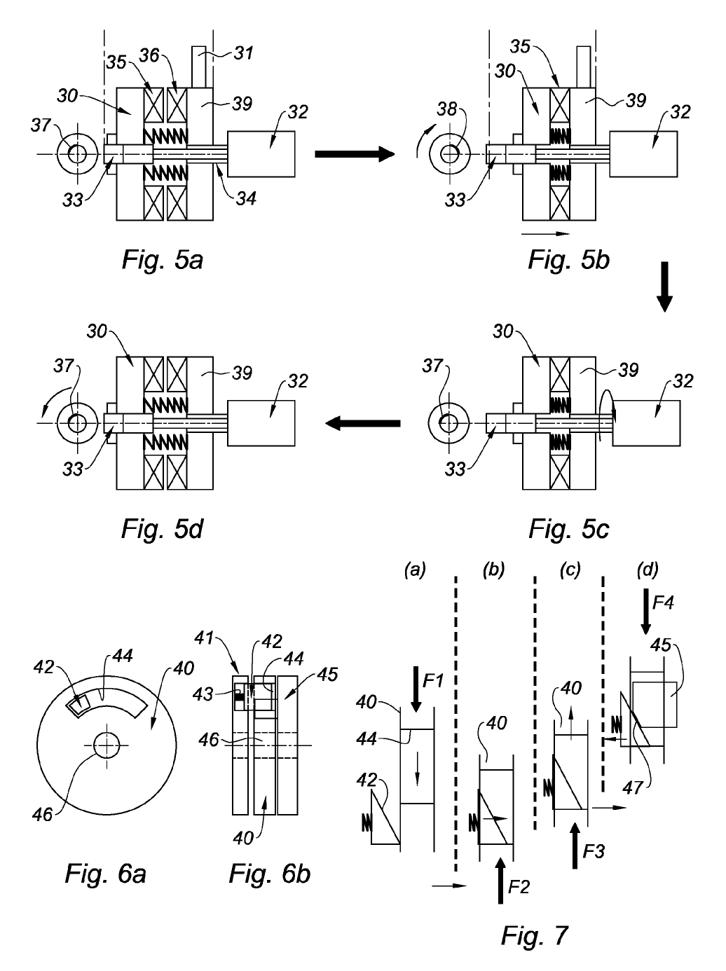

In FIGS. 5a to 5d, it has been represented four successive states of a means for mobilizing the active lock in a first form with claws. The means for mobilizing the active lock substantially includes two disks 30 and 39 on the faces which face claws 35 and 36 disposed in association. As a means for connecting the motor shaft 33 and any of the disks, the disk 30 is provided with a tapping which is meshed on a screw mounted at the end of the motor shaft 33. The disk 30 is secured to the pusher 3, 4 of the first form or 10 the second form of the active lock of the present disclosure. The disk 39 is provided with a bore which is mounted on a bearing 34 mounted on the shaft 33 in such a manner that the disk 39 is free on this motor shaft. The disk 39 is secured to the tilting bolt 2 of the first form or 11 second form of the active lock of the present disclosure.

The motor shaft 33 is driven by an electric motor 32. As in the two other forms of the means for mobilizing the active lock of the present disclosure, the electric motor 32 is activated by means of a programmed controller which cooperates with position sensors of the different pieces, namely the tilting bolt and the pusher (not represented) of either one of the aforementioned forms of the active lock of the present disclosure.

The bearing 34 is secured to the stationary structure on which the active lock is fastened. However, the two disks 30 and 39 are spaced apart from each other by a plurality of springs as it is known in the jaw clutching technique.

On FIG. 5a, the tilting bolt is in closed position thus blocking the moveable structure such as the sliding cowl of the thrust reverser during flight. The electric motor 32 associated with the means for mobilizing the active lock is actuated in order to mobilize the disk 30 which is moveable by its threading on the end screw of the motor shaft. The disk 30 carrying the claws 35 still cleared from the claws 36 of the disk 39 associated with the tilting bolt allows compressing the springs disposed between the two disks 30 and 39.

On FIG. 5b, the claws 35 and 36 are then meshed and the electric motor 32 pursuing its rotation then drives the pusher and the tilting bolt with a common movement, thus having for effect at the same time to open the active lock and push back the active structure such as the sliding cowl of the thrust reverser at the beginning of the deployment movement thereof. The opening state 38 of the tilting bolt is marked on the circle at the shaft 33 end having tilted by one quarter of a revolution on the closing position 37 marked on the same circle represented on FIG. 5a.

On FIG. 5c, the electric motor 32 stops its action. The tilting bolt is stopped in open position. However, the springs between the two claw disks 30 and 39 having been compressed, release their energy, thus having for effect to make the disk 30 revolve in the opposite direction, the disk ascends while revolving along the end screw of the shaft 33. The pusher associated with the disk 30 then resumes alone its rest position, the tilting bolt associated with the disk 39, stopped, remains in open position. The pusher is represented in the position 37 on the circle on the right of the end of the shaft 33.

On FIG. 5d, the electric motor 32 is reactivated in the opposite direction to that of FIGS. 5a and 5b in such a manner that the tilting bolt resumes the closing position 37 and the state of FIG. 5d is equivalent to that of FIG. 5a, representing active locking or closing state. In this case, the sliding cowl of the thrust reverser is closed and thrust reversal is impossible.

In FIGS. 6a and 6b, it has been represented a second form of the means for mobilizing the active lock of the present disclosure. A first disk 40 is mounted on an axis 46 and secured to the tilting bolt 2 or 11 of the active lock. A second disk 41 is also mounted on the axis 46. A third stationary disk 45 mounted on the axis 46 carries one or several non-represented spurs which will be described later on.

The first disk 40 secured to the tilting bolt is pierced right through by a groove 44 in which penetrates a cam 42 which is secured to the second disk 41 and secured to the pusher 3, 4 or 10 of the active lock. The cam 42 is pushed back towards the groove 44 of the first disk 40 by a spring 43 set up between the bottom of a housing of the second disk 41 in which the cam 42 is set up and the face facing the cam 42.

On FIG. 7, it has been represented 4 successive states from (a) to (d) of the means for mobilizing the active lock in this second form described on FIGS. 6a and 6b.

In the state (a), the cam 42 in the shape of a corner, slides on the surface of the first disk 40 outside the groove 44. The disk 40, under the action of the electric motor associated with the means for mobilizing the lock which drives the axis 46 (see FIGS. 6a and 6b), revolves in the direction of the arrow Fl in such a manner that the tilting bolt 2 (FIG. 1b) or 11 (FIG. 3b) of the active lock is closing, the pusher 3, 4 (FIG. 1a) or 10 (FIG. 3a) is in rest position.

In the following state (b), the cam 42 has fallen into the groove 42 of the first disk 40. The tilting bolt has arrived in closing position. The electric motor associated with the means for mobilizing the lock which drives the axis 46 (see FIGS. 6a and 6b) inverts the direction of rotation thereof in F2.

In the following state (c), the cam 42 meshed in the groove 44 of the first disk 40 revolves with it according to the arrow F3 in such a manner that the tilting bolt and the pusher of the active lock revolve in the same direction in order to simultaneously free the moveable structure and apply to it a thrust which thus allows freeing the sliding cowl of the thrust reverser.

In the following state (d), the first disk 40 and the groove 44 thereof intercept a stationary part constituted by any of the spurs secured to the disk 45 (FIG. 6b) which allows freeing the cam 42 from the groove 42, thus having for effect to clear the pusher which goes back to its rest position when the motor of the means for mobilizing the active lock secured to the axis 46 starts off again in the other direction F4.

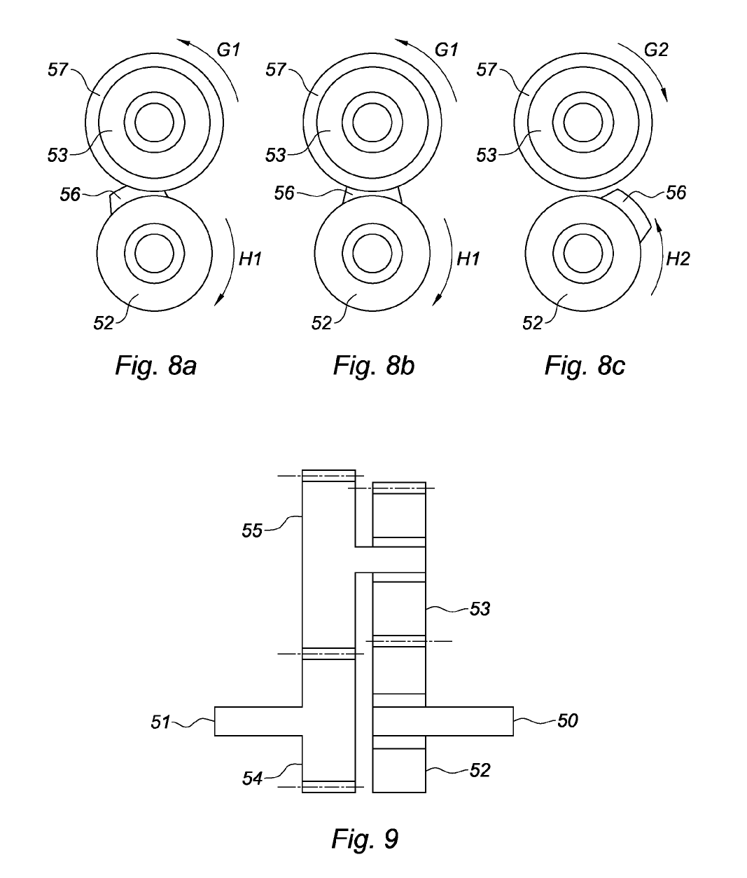

In FIGS. 8a to 8c, it has been represented three successive states of a third form of the means for mobilizing the active lock according to either one of the two forms of the active lock represented on FIGS. 1 to 4. A side view of any of the three views of FIGS. 8a to 8c is represented on FIG. 9.

The declutchable connection between the electric motor and the pusher or the tilting bolt is carried out by means of a toothed sector disposed on a wheel secured to the pusher. Two coaxial shafts are respectively associated 50 to the pusher and 51 to the tilting bolt. A wheel 52 is mounted on the shaft associated with the pusher 50. It has a toothed sector 56. It is briefly meshed with a toothed wheel 53 of which the toothing 57 is complete. This wheel 53 is mounted on a shaft secured to a wheel 55 having a complete toothing meshed on the complete toothing of a last wheel 54 secured to the shaft 51 associated to the tilting bolt.

On FIG. 8a, the active lock is in closed position. The means for mobilizing the active lock is associated with an electric motor which allows to put in rotation the wheel 52 in the direction H1, whereas the wheel 53 revolves in the direction G1. As the partial toothed sector 56 is meshed on the toothed crown 57 of the wheel 53 and the pusher is secured to the shaft 50, the pusher comes into action (3, 4 FIGS. 1a and following; 10, FIGS. 3a and following). On FIG. 8b, the tilting bolt (2, FIGS. 1; 11 FIGS. 3) being secured to the shaft 51, clears the locking interface of the moveable structure, such as the sliding cowl of the thrust reverser.

On FIG. 8c, the activation of the electric motor associated with the means for mobilizing the active lock is terminated. Elastic return means (not represented) are applied to the pusher in order to bring it back in rest position, the wheel 52 thus revolving in the direction H2 and the wheel 53 starting to bring the tilting bolt on the shaft 51 by revolving in the direction G2 when the sector 56 is meshed in the toothed crown 57.

The electric motor associated with the means for mobilizing the active lock, in this third form, is coupled by a reducer to any of the toothed wheels 53 or 55 by applying a reduction ratio determined by the dimensioning of the application. Likewise, the position and extent of the toothed sector 56 on the wheel 52 associated to the pusher are determined according to required relative movements of the pusher and the tilting bolt.

It is to be noted that the elastic return means of the pusher allow mobilizing the means for mobilizing the active lock in the opposite direction applied by the electric motor in such a manner that, in the absence of torque applied by this motor, the mobilization means is reversible.

Particular sequences of relative movements of the pusher and the tilting bolt have been described. It is obvious that the components of the declutchable connection means may be arranged differently by applying the teaching of the present disclosure in order to be suitable for other sequences.

What is claimed is:

1. An active lock secured to a stationary structure and which cooperates with an interface for locking a moveable structure by means of a tilting bolt driven by an electric motor, wherein the tilting bolt is tiltably mounted with a pusher pushing back the movable structure from the stationary structure during a deployment of the moveable structure relative to the stationary structure driven by the electric motor controlled by a means for mobilizing the active lock according to a determined sequence of movements of at least one of the tilting bolt and the pusher.

2. The active lock according to claim 1, wherein the tilting bolt and the pusher are mounted on shafts driven by the means for mobilizing the active lock and having a common axis, the tilting bolt assumes a hook shape, and the pusher includes an articulated latch on a lever for applying a thrust force during the start of the deployment of the moveable structure relatively to the stationary structure.

3. The active lock according to claim 1, wherein the tilting bolt and the pusher are mounted on shafts driven by the means for mobilizing the active lock having a common axis, the tilting bolt assumes a hook shape, and the pusher includes an end in contact with the moveable structure in its closing state having a cam profile for applying a thrust force during the start of the deployment of the moveable structure relatively to the stationary structure.

4. The active lock according to claim 1, wherein the means for mobilizing the active lock includes declutchable connection means between the electric motor of the active lock and the tilting bolt or between the electric motor of the active lock and the pusher, in such a manner that a determined sequence of movements of the tilting bolt and pusher be applied during the deployment of the moveable structure.

5. The active lock according to claim 4, wherein the declutchable connection means include claws respectively associated to the tilting bolt and the pusher, cooperating with elastic means which repel them from each other when the electric motor connected to any of the claws ceases to be active, and wherein any of claw disks is driven on a shaft of the electric motor, the connection between the shaft and any of the disks, the claws and the control of the electric motor being arranged for determining the sequence of movements.

6. The active lock according to claim 4, wherein the declutchable connection means include a first disk having a groove formed and associated to the tilting bolt, the groove cooperating with at least one cam mounted on a second disk associated with the pusher and at least one spur on a stationary disk of which relative positions and dimensions, the activation of the electric motor coupled to the at least any of the disks of the declutchable connection means, determine the sequence of movements.

7. The active lock according to claim 4, wherein the declutchable connection means include a plurality of toothed wheels, meshed by one of them to a wheel driving the electric motor, a toothed wheel of said plurality carrying a shaft associated with the tilting bolt and another toothed wheel of said plurality carrying a shaft associated with the pusher, any of the wheels associated with the pusher or the tilting bolt including a simple toothed sector and being returned by elastic means in a rest position when the electric motor is not actuated, the wheels and the toothed sector being arranged for determining the sequence of movements.

8. A thrust reverser for turbojet engine nacelle, incorporating at least one active lock according to claim 1, wherein the stationary structure is associated with the turbojet engine nacelle, and the moveable structure is associated with at least one sliding cowl of the thrust reverser.
